(19) United States
(12) Patent Application Publication
(10) Pub. No.: US 2012/0096564 A1
(43) Pub. Date: Apr. 19, 2012

(54) DATA INTEGRITY PROTECTING AND VERIFYING METHODS, APPARATUSES AND SYSTEMS

(75) Inventor: Ji LI, Beijing (CN)

(73) Assignee: Sony Corporation, Tokyo (JP)

(21) Appl. No.: 13/271,590

(22) Filed: Oct. 12, 2011

(30) Foreign Application Priority Data
Oct. 13, 2010 (CN) 201010515637.6

(51) Int. Cl. G06F 17/30

(52) U.S. Cl. 726/26; 707/698; 707/E17.001

(57) ABSTRACT

The disclosure provides data integrity protecting and verifying methods, apparatuses and systems. A data integrity protecting method include: calculating a Hash value of each of the data blocks by using a first Hash function, to obtain a plurality of block Hash values which form a first series of Hash values; calculating a second series of Hash values based on the first series of Hash values, the second series of Hash values comprising a plurality of chain Hash values, each of which being associated with a corresponding block Hash value in the first series of Hash values and being associated with a neighbor chain Hash value in the second series of Hash values, wherein the first series of Hash values and the second series of Hash values used as integrity information of the data; and generating verification information of the data by using a last chain Hash value.

### FIELD

The disclosure relates to integrity protection of electronic data, and in particular, to methods, apparatuses and systems for protecting or verifying the integrity of electronic data.

### BACKGROUND

Compared with paper media, electronic data, such as image, text, audio, video or the like, is prone to be tampered or there may occur data lost or error during transmission or storage of the electronic data. In many applications, a user generally needs to check the integrity of the electronic data to ensure that the data is not tampered or lost or is not erroneous. For example, with the promulgation of laws such as the Electronic Signature Law, the electronic data, like the paper media, can be used as evidence of court. Therefore, to ensure the integrity of electronic data is becoming more and more important.

### SUMMARY

The following presents a simplified summary of the disclosure in order to provide a basic understanding of some aspects of the disclosure. This summary is not an exhaustive overview of the disclosure. It is not intended to identify key or critical elements of the disclosure or to delineate the scope of the disclosure. Its sole purpose is to present some concepts in a simplified form as a prelude to the more detailed description that is discussed later.

According to an aspect of the disclosure, a data integrity protecting method is provided, which may include: dividing data into a plurality of data blocks; calculating a Hash value of each of the data blocks by using a first Hash function, to obtain a plurality of block Hash values which form a first series of Hash values; calculating a second series of Hash values based on the first series of Hash values by using a second Hash function, wherein the second series of Hash values includes a plurality of chain Hash values, each of which is associated with a corresponding block Hash value in the first series of Hash values and associated with a neighbor chain Hash value in the second Hash chain; and generating verification information of the data by using a last chain Hash value in the second series of Hash values.

According to another aspect of the disclosure, a data integrity protecting apparatus is provided, which may include: a data dividing device configured to divide data into a plurality of data blocks; an integrity information generating device configured to calculate a Hash value of each of the data blocks by using a first Hash function to obtain a plurality of block Hash values which form a first series of Hash values and further configured to calculate a second series of Hash values based on the first series of Hash values by using a second Hash function, wherein the second series of Hash values includes a plurality of chain Hash values, each of which is associated with a corresponding block Hash value in the first series of Hash values and associated with a neighbor chain Hash value in the second series of Hash values; and a verification information generating device configured to generate verification information of the data by using a last chain Hash value in the second series of Hash values.

According to another aspect of the disclosure, a data integrity verifying method is provided, which may include: dividing data to be verified into a plurality of data blocks; calculating a Hash value of each of the data blocks by using a first Hash function to obtain a plurality of block Hash values which form a first series of Hash values, wherein each of the plurality of block Hash values in the first series of Hash values corresponds to one of the plurality of data blocks; calculating a second series of Hash values based on the first series of Hash values by using a second Hash function, wherein the second series of Hash values includes a plurality of chain Hash values, each of which is associated with a corresponding block Hash value in the first series of Hash values and is associated with a neighbor chain Hash value in the second series of Hash values; and determining whether the data to be verified is in integrity according to the last chain Hash value of the second series of Hash values and the verification information of the data to be verified.

According to another aspect of the disclosure, a data integrity verifying apparatus is provided, which may include a data dividing device configured to divide data to be verified into a plurality of data blocks; and a Hash calculating device configured to calculate a Hash value of each of the data blocks by using a first Hash function to obtain a plurality of block Hash values which form a first series of Hash values, wherein each block Hash value in the first series of Hash values corresponds to one of the plurality of data blocks, the Hash calculating device may be further configured to calculate a second series of Hash values based on the first series of Hash values by using a second Hash function, the second series of Hash values includes a plurality of chain Hash values, each of which is associated with a corresponding block Hash value in the first series of Hash values and is associated with a neighbor chain Hash value in the second series of Hash values. The apparatus may further include a verifying device configured to determine whether the data to be verified is in integrity according to the last chain Hash value of the second series of Hash values and the verification information of the data to be verified.

According to another aspect of the disclosure, a data integrity protecting system including the above protecting apparatus and the above verifying apparatus is provided.

In addition, some embodiments of the disclosure further provide computer program for realizing the above methods.

Further, some embodiments of the disclosure further provide computer program products in at least the form of computer-readable medium, upon which computer program codes for realizing the above methods are recorded.

### BRIEF DESCRIPTION OF DRAWINGS

The above and other objects, features and advantages of the embodiments of the disclosure can be better understood with reference to the description given below in conjunction with the accompanying drawings, throughout which identical or like components are denoted by identical or like reference signs. In addition the components shown in the drawings are merely to illustrate the principle of the disclosure. In the drawings:

FIG. 1 is a schematic flow chart illustrating a method for protecting data integrity according to an embodiment of the disclosure;

FIG. 2 is a schematic flow chart illustrating a method for verifying data integrity according to an embodiment of the disclosure;

FIG. 3(A) is a schematic flow chart illustrating an example of generating the second series of Hash values based on the first series of Hash values;

FIG. 3(B) is a schematic flow chart illustrating another example of generating the second series of Hash values based on the first series of Hash values;

FIG. 4 is a schematic diagram illustrating a system for protecting data integrity according to an embodiment of the disclosure;

FIG. 5 is a schematic diagram illustrating a system for protecting data integrity according to another embodiment of the disclosure;

FIG. 6(A) is a schematic diagram illustrating an example of generating integrity information having a structure of double Hash chain and verifying the integrity of the data by using such structured integrity information;

FIG. 6(B) is a schematic diagram illustrating another example of generating integrity information having a structure of double Hash chain and verifying the integrity of the data by using such structured integrity information;

FIG. 7 is a schematic diagram illustrating an example of verifying the integrity of the data by using the last chain Hash value in the second series of Hash values;

FIG. 8 is a schematic diagram illustrating another example of verifying the integrity of the data by using the last chain Hash value in the second series of Hash values;

FIG. 9 is a schematic diagram illustrating an example of a method of locating data block(s) containing error;

FIG. 10 is a schematic diagram illustrating another example of a method of locating data block(s) containing error;

FIG. 11 is a schematic diagram illustrating another example of a method of locating data block(s) containing error;

FIG. 12(A), (B), (C) are schematic diagrams illustrating methods of dividing image or video data, respectively;

FIG. 13 is a schematic block diagram illustrating an apparatus of protecting data integrity according to an embodiment;

FIG. 14 is a schematic block diagram illustrating an apparatus of protecting data integrity according to another embodiment;

FIG. 15 is a schematic block diagram illustrating an apparatus of verifying data integrity according to an embodiment; and

FIG. 16 is a schematic block diagram illustrating the structure of computer for realizing the disclosure.

### DETAILED DESCRIPTION OF EMBODIMENTS

Some embodiments of the present disclosure will be described in conjunction with the accompanying drawings hereinafter. It should be noted that the elements and/or features shown in a drawing or disclosed in an embodiments may be combined with the elements and/or features shown in one or more other drawing or embodiments. It should be further noted that some details regarding some components and/or processes irrelevant to the disclosure or well known in the art are omitted for the sake of clarity and conciseness.

Some embodiments of the present disclosure provide methods, apparatuses and systems for protecting and verifying the integrity of electronic data. It should be noted that the term “data” mentioned in the embodiments or solutions of the disclosure refers to “electronic data”, and may be electronic data of any form, such as image, text, video, audio or any combination thereof. However, the disclosure is not limited to any examples described herein.

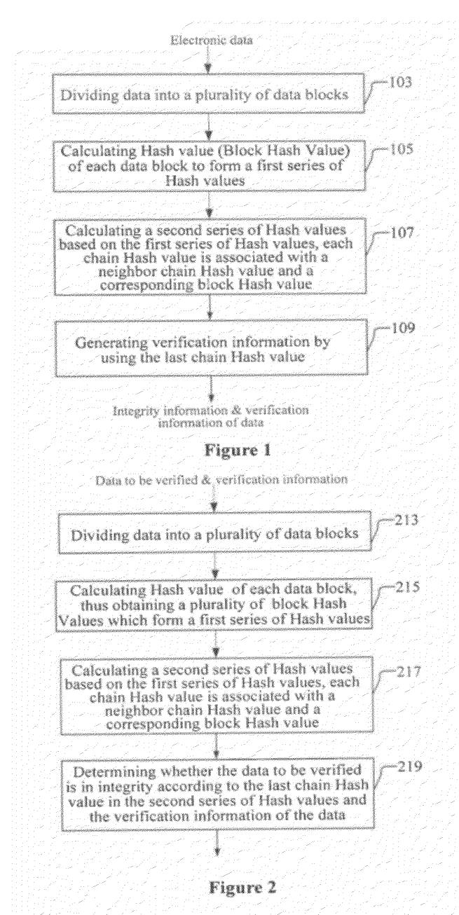

FIG. 1 is a schematic flow chart illustrating a data integrity protecting method according to an embodiment of the disclosure. In the embodiment shown in FIG. 1, an information generator may generate double Hash chain associated with the data to be protected, as the integrity information of the data.

As shown in FIG. 1, the data integrity protecting method may include steps 103, 105, 107 and 109.

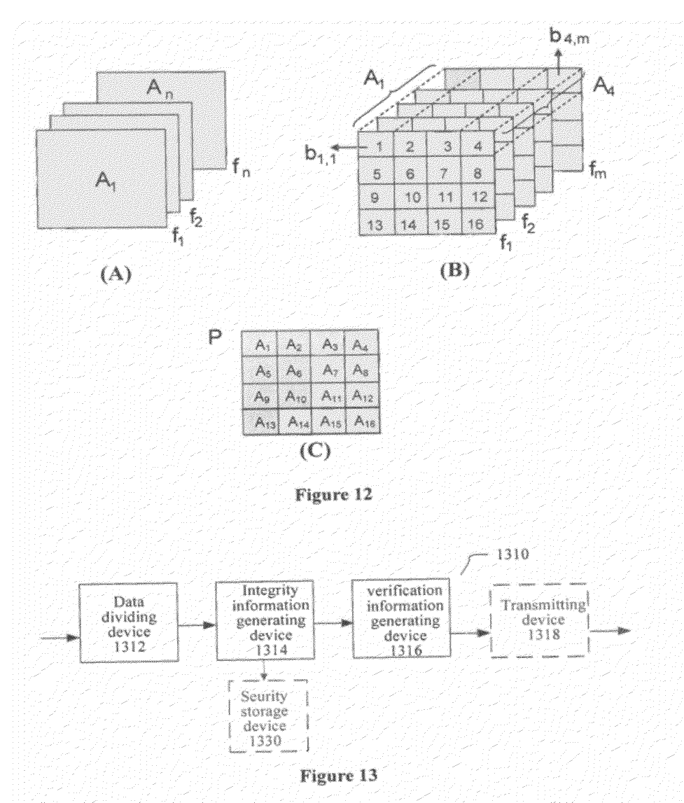

In particular, in step 103, an apparatus at the information generator (simplified as information generator) divides the data to be protected into a plurality of data blocks. The data may be divided in any order as appropriate. For example, the data may be divided into data blocks in time or transmission order. For another example, the data may be divided into data blocks in spatial order. FIG. 12(C) shows an example of dividing an image into multiple blocks spatially. In the example, the image P is divided into 16 blocks A₁-A₁₆. For another example, the data may be divided into data blocks in both the spatial and time orders. As shown in the example of FIG. 12(A), the image sequence is divided in time order, in which each image frame is regarded as a data block, that is, each image frame f₁, f₂, . . . , or fₙ is a data block A₁, A₂, . . . , or Aₙ. While in the example of FIG. 12(B), the image sequence is firstly divided into multiple sets in time sequence, each set includes a plurality of image frames f₁, f₂, . . . , fₘ. Then each frame in each set is divided into a plurality of regions in spatial sequence, and multiple regions which have the same position in the plurality of frames in a set form a data block. In this example, the set of image frames f₁, f₂, . . . , fₘ is divided into 16 data blocks A₁-A₁₆, each data block includes a plurality of regions which correspond to the same position in the set of image frames f₁, f₂, . . . , fₙ. That is, Aᵢ={b_{i,1}, . . . b_{i,j}, b_{i,m}}, j=1, 2, . . . , m, i=1, . . . , 16. It should be noted that the data may be divided in any manner as appropriate and the disclosure is not limited to the above examples.

Then in step 105, the information generator calculates the Hash value of each data block by using a Hash function (referred to as the first Hash function). The Hash value of each data block thus calculated is called a block Hash value hereinafter. Thus, a plurality of block Hash values are obtained, each block Hash value corresponds to a data block. These block Hash values form a first series of Hash values.

Then in step 107, the plurality of block Hash values in the first series of Hash values are chained in sequence by using an iterative Hash chain, thereby forming a second series of Hash values of the data. The second series of Hash values includes a plurality of Hash values, each of which is called hereinafter as “a chain Hash value” so as to distinguish it from the block Hash value in the first series of Hash values. In particular, an iterative computation may be performed based on the first series of Hash values by using a Hash function (hereinafter referred to as the second Hash function), so as to obtain the second series of Hash values, each chain Hash value in the second series of Hash values is not only associated with a corresponding block Hash value in the first series of Hash values, but also associated with a neighbor chain Hash value in the second series of Hash values. The first series of Hash values and the second series of Hash values may be used as the integrity information of the data.

As an example, the second Hash function used in calculating the second series of Hash values may be a Hash function same with the first Hash function used in calculating the first series of Hash values. As another example, the second Hash function may be a Hash function different from the first Hash function.

It will be appreciated that any appropriate method may be used to calculate the hash values. For example, the first Hash function or the second Hash function may be SHA256 or SHA512 (wherein SHA refers to Secure Hash Algorithm) or a new Hash function selected by NIST (National Institute of Standards and Technology) in next generation Hash function competition or the like. Of course, the disclosure is not limited to these.

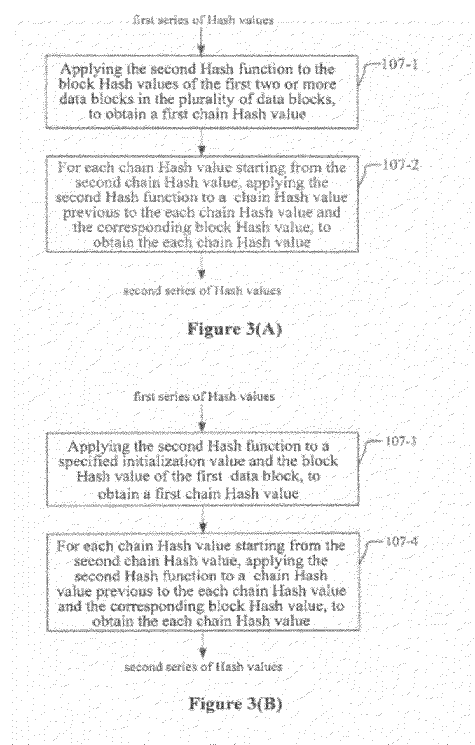

FIG. 3(A) shows an example of a method of calculating the second series of Hash values. As shown in FIG. 3(A), the method of calculating the second series of Hash values based on the first series of Hash values may include steps 107-1 and 107-2. In step 107-1, the first chain Hash value of the second series of Hash values is calculated. In particular, the Hash value obtained by using the block Hash values of the first two or more data blocks among the plurality of data blocks as independent variables of the second Hash function is used as the first chain Hash value. Then in step 107-2 the chain Hash values following the first chain Hash value are calculated in order. In particular, each chain Hash value, from the second chain Hash value, in the second series of Hash values may be calculated by using its previous chain Hash value and a block Hash value corresponding thereto as the independent variables of the second Hash function.

FIG. 3(B) shows another example of a method of calculating the second series of Hash values. As shown in FIG. 3(B), the method of calculating the second series of Hash values based on the first series of Hash values may include steps 107-3 and 107-4. In step 107-3, the first chain Hash value of the second series of Hash values is calculated. In particular, the Hash value obtained by using a specified initialization value and the first block Hash value in the first series of Hash values (i.e. the block Hash value of the first data block of the plurality of data blocks) as independent variables of the second Hash function is used as the first chain Hash value. The specified initialization value may be the last Hash value or the verification information of the previous set of data, or may be data that contains specified verification information (such as time information, data source information or any additional information defined by user). Step 107-4 is similar to step 107-2 in FIG. 3(A), the description of which is not repeated herein.

It is supposed that the data is divided into a plurality of data blocks A₁, A₂, . . . , Aₙ, n>1, and the block Hash values of the data blocks are represented by h₁, h₂, . . . , hₙ, respectively:

hᵢ=H1(Aᵢ), i=1, . . . , n, (1)

Wherein H1( ) represents the first Hash function, which may be any appropriated Hash function.

Based on the method of FIG. 3(A), supposing the chain Hash values in the second series of Hash values are represented by h′ₘ, h′ₘ₊₁, . . . , h′ₙ, these chain Hash values may be calculated by the following formulas:

h′ₘ=H2(hₘ, hₘ₋₁, . . . , h₁), (2)

h′ₘ₊₁=H2(hₘ₊₁, h′ₘ), . . . , h′ₙ=H(hₙ, h′ₙ₋₁) (3)

Wherein 2≦m<n, n represents the number of the data blocks. Preferably, m=2.

Based on the method of FIG. 3(B), the chain Hash values h′₁, h′₂, . . . , h′ₙ may be calculated by the following formulas:

h′₁=H2(h₁,IV), (4)

h′ᵢ=H2(hᵢ, h′ᵢ₋₁) (5)

Wherein IV represents the specified initialization value, 2≦i≦n, n represents the number of the data blocks.

In the above formulas (2)-(5), H2( ) represents the second Hash function, which may be any appropriated Hash function. H2( ) may be the same with H1( ), or may be different from H1( ).

It will be appreciated that the above examples are merely illustrative, rather than exhaustive. The second series of Hash values may be calculated by any other appropriate methods, as long as the block Hash values in the first series of Hash values may be chained in a chain structure by the chain Hash values in the second series of Hash values.

Then in step 109, the last chain Hash value of the second series of Hash values is used to generate the verification information of the data:

verification information=Verify(h′ₙ) (6)

Wherein Verify( ) represents a verifying algorithm. It will be appreciated that any appropriate verifying algorithms may be used. As an example, Verify( ) may be a digital signature algorithm, and the verification information may be the signature information obtained by performing digital signature to the last chain Hash value (any appropriate method may be used to perform the signing, the disclosure is not limited to any particular algorithm). As another example, Verify( ) may a method of calculating a time stamp, and the verification information may be time stamp information generated by using the last chain Hash value and the time information (any appropriate method may be used to calculate the time stamp, the disclosure is not limited to any particular algorithm). As another example, the verification information may include both digital signature and time stamp information. However, the disclosure is not limited to these.

In the method shown in FIG. 1, double Hash chain may be obtained and used as the integrity information of the data to be protected.

FIG. 2 is a schematic flow chart illustrating a data integrity verifying method according to an embodiment of the disclosure. In the embodiment of FIG. 2, an apparatus of information verifier (simplified as information verifier) may generate double Hash chain of the data to be verified and use such Hash information to verify the integrity of the data.

As shown in FIG. 2, the verifying method may include steps 213, 215, 217 and 219.

Firstly the information verifier may generate the double Hash chain of the data to be verified by means of the same method used by the information generator. In particular, in step 213 the data to be verified is divided into a plurality of data blocks by means of the same data dividing method as that of the information generator, the description of which is not repeated. For example, the data blocks obtained by dividing the data to be verified may be represented by RA₁, RA₂, . . . , RAₙ(n>1, n represents the number of data blocks).

Then in step 215, the Hash value of each data block is calculated by using the first Hash function, thus obtaining a plurality of block Hash values which form the first series of Hash values. Each block Hash value in the first series of Hash values corresponds to one of the plurality of data blocks. The same Hash function as that used by the information generator may be utilized to calculate the Hash values, the description of which is not repeated. It is supposed that the block Hash values calculated based on the data to be verified are represented by h_{R1}, h_{R2}, . . . , h_{Rn}, h_{Ri}=H1(RAᵢ), i=1, . . . , n, and H1( ) represents the first Hash function which may be any appropriate Hash function.

In step 217, the information verifier chains the block Hash values in the first series of Hash values by using an iterative Hash chain, thus forming the second series of Hash values. In particular, the information verifier may calculate the second series of Hash values based on the first series of Hash values by using the second Hash function. The second series of Hash values contains a plurality of chain Hash values, each chain Hash value is associated with a corresponding block Hash value in the first series of Hash values and is associated with a neighbor chain Hash value in the second series of Hash values. The information verifier calculates the second series of Hash values by using the same method as that used by the information generator, such as the method in the embodiments or examples described with reference to FIG. 2, or FIG. 3(A), or FIG. 3(B).

In an example of using the method shown in FIG. 3(A) to calculate the chain Hash values, supposing that the chain Hash values in the second series of Hash values calculated by the information verifier based on the data to be verified are represented by h′_{Rm}, h′_{R(m+1)}, . . . , h′_{Rn}, then the following can be obtained: h′_{Rm}=H2(h_{Rm}, . . . , h_{R1}), h′_{R(m+1)}=H2(h_{R(m+1)}, h′_{Rm}), . . . , h′_{Rn}=H2(h_{Rn}, h′_{R(n-1)}), 2≦m<n. Here H2( ) represents the second Hash function which may be any Hash function as appropriate. H2( ) may be the same Hash function as H1( ), or may be different from H1( ).

In an example of using the method shown in FIG. 3(B) to calculate the chain Hash values, supposing that the chain Hash values in the second series of Hash values calculated by the information verifier based on the data to be verified are represented by h′_{R1}, h′_{R2}, . . . , h′_{Rn}, then the following can be obtained: h′_{R1}=H2(h_{R1}, IV), h′_{R2}=H2(h_{R2}, h′_{R1}), . . . , h′_{Rn}=H2(h_{Rn}, h′_{R(n-1)}). Here IV represents the specified initialization value, H2( ) represents the second Hash function which may be any Hash function as appropriate. H2( ) may be the same Hash function as H1( ), or may be different from H1( ).

In step 219, the information verifier may determine whether the data to be verified is in integrity according to the last chain Hash value (such as h′_{Rn}) calculated based on the data to be verified and the verification information (such as the verification information calculated by using h′ₙ) from the information generator.

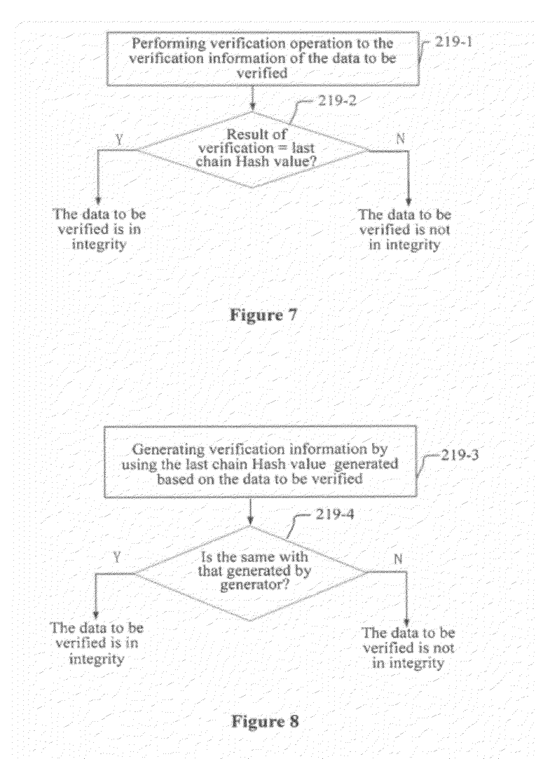

In particular, for example, the method shown in FIG. 7 or FIG. 8 may be used to perform the verification. In an example of using the method of FIG. 7, the verification information Verify(h′ₙ) from the information generator may be used to deduce in a reverse direction the chain Hash value h′ₙ (e.g. as shown in step 219-1), that is, a verification operation is performed based on the verification information from the information generator. Then in step 219-2, the result h′ₙ of the reverse deduction is compared with the last chain Hash value h′_{Rn} obtained in step 217, and if they are the same, it may be determined that the data is in integrity, otherwise, it may be determined that the data is not in integrity. In another example of using the method of FIG. 8, the last chain Hash value h′_{Rn} calculated based on data to be verified may be used to generate the verification information Verify(h′_{Rn}), by using the same method as that utilized by the information generator (as shown in step 219-3). Then in step 219-4, the verification information Verify(h′_{Rn}) is compared with the verification information Verify(h′ₙ) from the information generator, and if they are the same, it may be determined that the data is in integrity, otherwise, it may be determined that the data is not in integrity.

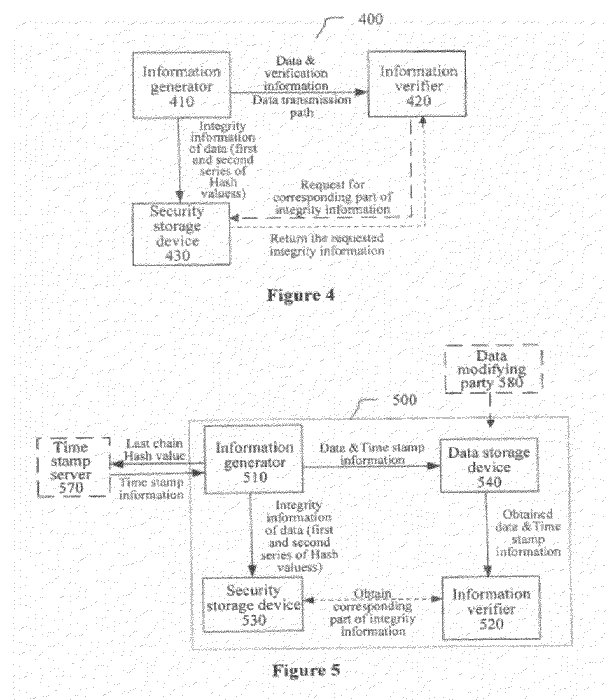

FIG. 4 and FIG. 5 are schematic diagrams illustrating a data integrity protecting system based on the embodiments of FIG. 1 and FIG. 2, respectively.

The system 400 as shown in FIG. 4 may include an information generator (i.e. an apparatus of the information generator) 410, an information verifier (i.e. an apparatus of the information verifier) 420 and a security storage device 430. The information generator 410 may generate the integrity information of data and the verification information of the data by using the methods described above with reference to FIG. 1 and FIG. 3. Then the information generator 410 may store the generated integrity information (the first series of Hash values and the second series of Hash values) in the security storage device 430, and may transmit the data and the verification information to the information verifier 420 by using any appropriate data transmission manner (which may be any wired or wireless transmission manner as appropriate, the disclosure is not limited to any particular example). Error or lost may occur in the data during transmission of the data, and the information verifier 420 may verify the integrity of the received data by using the method described above with reference to FIG. 3.

The system 500 as shown in FIG. 5 may include an information generator (i.e. an apparatus of the information generator) 510, an information verifier (i.e. an apparatus of the information verifier) 520, a data storage device 540 and a security storage device 530. The information generator 510 may generate the integrity information (including the first series of Hash values and the second series of Hash values) of data by using the methods described above with reference to FIG. 1 and FIG. 3. The information generator 510 may send the last chain Hash value of the second series of Hash values to a time stamp server 570. The time stamp server 570 generates time stamp information based on the last chain Hash value and time information (the server may utilize any appropriate method to generate the time stamp, the disclosure is not limited to any particular example), and returns the time stamp information to the information generator 510. The information generator 510 stores the generated integrity information in the security storage device 530, and stores the data and the time stamp information in the data storage device 540.

The data stored in the data storage device 540 may be tampered or modified by a data modifying party. For example, the data managing party may wish one segment or some segments in the data to be unseenable by others and thus may modify or mask the segment(s) (that is the data managing party may be a data modifying party 580). For another example, the data stored in the data storage device 540 may be attacked and tampered by some attacker (that is such attacker may be a data modifying party 580). When obtaining from the data storage device 540 the data and the verification information (e.g. time stamp), the information verifier 520 may verify the integrity of the obtained data by using the method described above with reference to FIG. 3.

As particular examples, the security storage device in the above embodiments or examples may be provided in the apparatus of the information generator, or may be independent of the apparatus of the information generator. The security storage device may be a nonvolatile memory, to ensure the security of the integrity information of the data.

The above systems 400 or 500 may be applied to various scenarios, such as video monitoring or intellectual property protection or the like.

For example, as a video monitoring system, the information generator apparatus 400 or 500 may be provided in a camera, to generate the integrity information and the verification information based on the data captured by the camera. Or, the information generator apparatus 400 or 500 may be separated from the camera and may be connected to it via any appropriate manner (wired or wireless) to receive the data captured by the camera and generate the integrity information and the verification information. The captured data and the verification information may be stored in the data storage device (such as a data server). The generated integrity information may be stored in the security storage device. The security storage device may be a memory built in the camera, or may be other types of memories. The captured data and the verification information may also be sent to the information receiving party (the information verifier) via any appropriate communication channel.

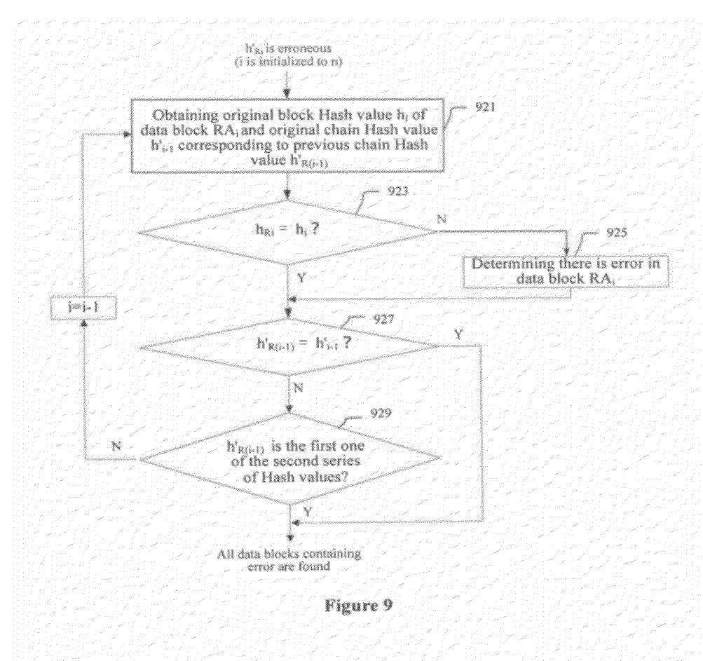

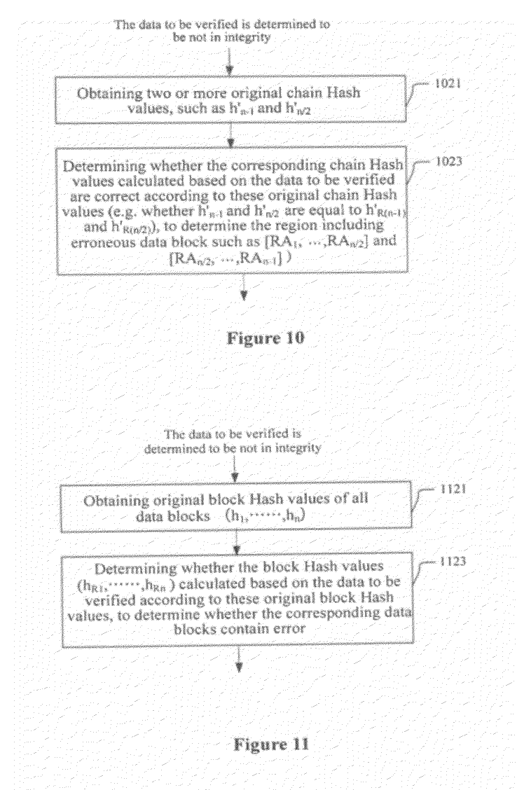

In the data to be verified, it is possible that only part of the data is erroneous, while other parts are correct. As a particular embodiment, the information verifier may locate the erroneous data block(s) according to the integrity information (e.g. stored in the security storage device) of the data. The information verifier may query the first series of Hash values and the second series of Hash values (for clarity the Hash values in the chains are referred to as original block Hash value and original chain Hash value, respectively) generated by the information generator based on the original data, to determine which data block(s) in the plurality of data blocks to be verified is erroneous. In particular, the information verifier may locate the erroneous data block by using for example the method as shown in FIG. 9 or FIG. 10 or FIG. 11, verify the integrity of other parts and verify the signature information and the time stamp information of the data.

In the example as shown in FIG. 9, the method of locating an erroneous data block begins at step 921. It is supposed that the verifier has determined that the data to be verified is not in integrity based on the method shown in FIG. 2 (i.e. h′_{Rn} is incorrect), then a retrospective computation may be performed. That is, starting from the last chain Hash value, the previous chain Hash value may be requested to, for example, the security storage device (430 or 530) which stores the integrity information. In particular, in step 921, the original block Hash value hₙ of the last data block and the original chain Hash value h′ₙ₋₁ corresponding to the previous chain Hash value h′_{R(n-1)} may be obtained from the security storage device. In step 923, the block Hash value h_{Rn} of the last data block RAₙ is compared with its original block Hash value hₙ, to determine whether the last data block contains error. If the block Hash value h_{Rn} of the last data block RAₙ is different from its original block Hash value hₙ, it is determined that the last data block RAₙ contains error (step 925); otherwise, it is determined that the data block RAₙ is correct. Then in step 927, it is further determined whether the previous chain Hash value h′_{R(n-1)} is the same with its corresponding original chain Hash value h′ₙ₋₁; and if yes, it is determined that the data blocks (RA₁, . . . , RAₙ₋₁) preceding the data block RAₙ each do not contain error, thus ending the the process of locating erroneous data block. If the previous chain Hash value h′_{R(n-1)} is different from its corresponding original chain Hash value h′ₙ₋₁, it is further determined whether h′_{R(n-1)} is the first one in the second series of Hash values, and if yes, the processing is ended; otherwise, the original block Hash value hₙ₋₁ of the previous data block and the chain Hash value h′ₙ₋₂ corresponding to the previous chain Hash value h′_{R(n-2)} are further requested to the security storage device, and the processing in step 921-927 is repeated. By using the method of FIG. 9, the closer to the last data block in position the data block containing error is, the less the number of queries (i.e. the number of times of repeating the step 921-927); whereas the more distant to the last data block in position the data block containing error is, the more the number of queries. The average number of queries is n/2, and the average number of times of computation is also n/2.

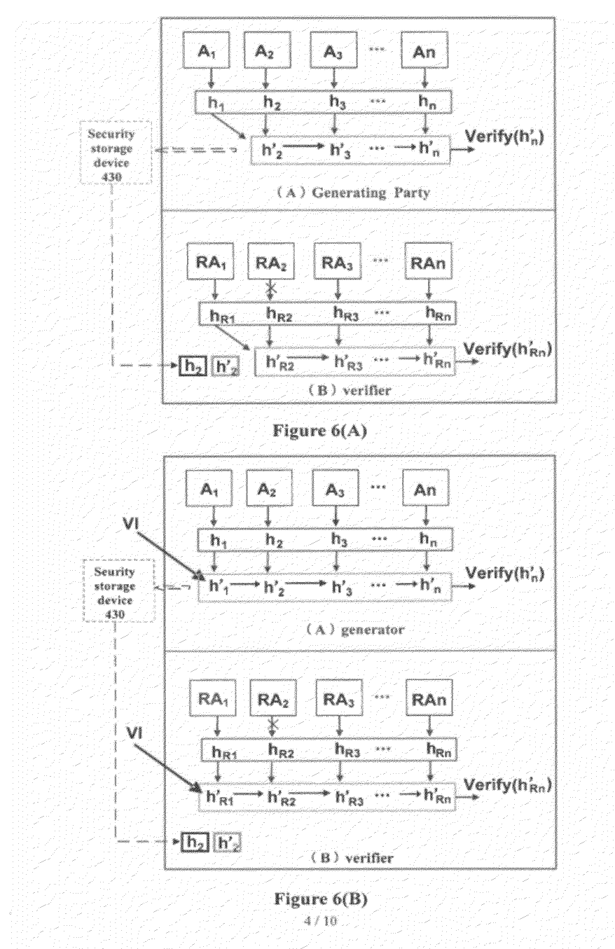

FIG. 6(A) and FIG. 6(B) illustrates two particular examples. In the example of FIG. 6(A), the information generator and the information verifier both utilize the method of FIG. 3(A) to calculate the second series of Hash values, wherein m=2. In particular, the information generator generates the original block Hash values h₁, h₂, . . . , hₙ and the original chain Hash values h′₂, h′₃, . . . , h′ₙ, as well as the verification information Verify(h′ₙ) based on the original data blocks A₁, A₂, . . . , Aₙ. Upon obtaining the data to be verified, the information verifier generates the block Hash values h_{R1}, h_{R2}, . . . , h_{Rn} and the chain Hash values h′_{R2}, h′_{R3}, . . . , h′_{Rn}, as well as the verification information Verify(h′_{Rn}), based on the data blocks RA₁, RA₂, . . . , RAₙ. By comparing Verify(h′ₙ) with Verify(h′_{Rn}), it is determined that the two are different from each other, and thus it may be determined that the data to be verified is not in integrity. By requesting the original Hash values to the security storage device, it may be determined that the data block RA₂ contains error. In the example of FIG. 6(B), the information generator and the information verifier both utilize the method of FIG. 3(B) to calculate the second series of Hash values. In particular, the information generator generates the original block Hash values h₁, h₂, . . . , hₙ and the original chain Hash values h′₁, h′₂, . . . , h′ₙ, as well as the verification information Verify(h′ₙ), based on the original data blocks A₁, A₂, . . . , Aₙ and the specified initialization value IV. Upon obtaining the data to be verified, the information verifier generates the block Hash values h_{R1}, h_{R2}, . . . , h_{Rn} and the chain Hash values h′_{R1}, h′_{R2}, . . . , h′_{Rn}, as well as the verification information Verify(h′_{Rn}), based on the data blocks RA₁, RA₂, . . . , RAₙ and the same initialization value IV. By comparing Verify(h′ₙ) with Verify(h′_{Rn}), it is determined that the two are different from each other, and thus it may be determined that the data to be verified is not in integrity. By requesting the original Hash values to the security storage device, it may be determined that the data block RA₂ contains error.

In the example as shown in FIG. 10, the original Hash values of two or more data blocks may be requested in one query. The two or more data blocks may be distributed at different positions in the whole set of data blocks. By using the original Hash values obtained from the query, it may be determined which one of the data regions delimited by these two or more data blocks contains erroneous data block. As a particular example, the method may be a dichotomy method. In step 1021, two chain Hash values, e.g. h′ₙ₋₁ and h′_{n/2}, in the original second series of Hash values is obtained for example from the security storage device. Then in step 1023, by using the two original chain Hash values, it is determined whether the corresponding chain Hash value h′_{R(n-1)} and h′_{R(n/2)} calculated by the verifier based on the data to be verified are correct, to determine whether the data region [RA₁, . . . , RA_{n/2}] or [RA_{n/2}, . . . , RAₙ₋₁] contains erroneous data block. In particular, if h′ₙ₋₁≠h′_{Rn(n-1)} and h′_{n/2}=h′_{R(n/2)}, it may be determined that the region [RA_{n/2}, . . . , RAₙ₋₁] contains erroneous data block, while the region [RA₁, . . . , RA_{n/2}] contains no error. If h′_{n-1≠h′}_{R(n-1)} and h′_{n/2}≠h′_{R(n/2)}, it may be determined that the region [RA₁, . . . , RA_{n/2}] contains erroneous data block, and in this case the region [RA_{n/2}, . . . , RAₙ₋₁] may contain erroneous data block or may contain no error. Further, the information verifier may recalculate the chain Hash values of the data blocks following RA_{n/2} in the region [RA_{n/2}, . . . , RAₙ₋₁] according to the original chain Hash value h′_{n/2}. It is supposed that these recalculated chain Hash values are represented by h′_{U((n/2)+1)}, h′_{U((n/2)+2)}, . . . , h′_{U(n-1)}, wherein h′_{U((n/2)+1)}=H2 (h_{R((n/2)+1)}, h′_{n/2}), h′_{U(n/2+2)}=H2 (h_{R((n/2)+2)}, h′_{U((n/2)+1)}), h′_{U(n-1)}=H2 (h_{R(n-1)}, h′_{U(n-2)}). If the recalculated chain Hash value h′_{U(n-1)} is not the same with the original chain Hash value h′ₙ₋₁, that is h′_{U(n-1)}≠h′ₙ₋₁, it may be determined that the region [RA_{n/2}, . . . , RAₙ₋₁] also contains error. The data region determined to contain error may be used as the data region for next query. The steps 1021 and 1023 may be repeated, until all the erroneous data clocks are located. In the method shown in FIG. 10, if the total number of data blocks is n and one of the data blocks contains error, the average number of times of queries by using this method is log₂(n), and the average number of times of Hash calculation is n/2. The average number of times of queries by using the method of FIG. 10 is less than that of the method shown in FIG. 9.

In the example of FIG. 11, in step 1121 all the original block Hash values h₁, h₂, . . . , hₙ are obtained from for example the security storage device by one query. Then in step 1123 these original block Hash values are compared with the block Hash values h_{R1}, h_{R2}, . . . , h_{Rn} calculated by the verifier based on the data to be verified, respectively. Thus the erroneous data block(s) may be located. In the method as shown in FIG. 11, if the total number of data blocks is n and one of the data blocks contains error, the average number of times of queries by using this method is 1, the query traffic is n, and the average number of times of Hash calculation is n/2. Compared with the methods shown in FIG. 9 and FIG. 10, the number of times of queries by using the method of FIG. 11 is the least, but the query traffic is the maximum.

As an example, the information generator may transmit all of or part of the generated integrity information (the first series of Hash values and/or the second series of Hash values) to the information receiving party (e.g. the information verifier), together with the data and the verification information. If there is loss or error in the data clocks while there is no loss or error in the first series of Hash values (block Hash values) during data transmission, the information verifier may verify if there is (are) any data block(s) lost or containing error by using these transmitted block Hash values, and may regenerate the chain Hash values based on these transmitted block Hash values so as to verify the signature information of the data. If there are lost or error in both the data blocks and the first series of Hash values, the verifier may locate the erroneous data blocks and verify the integrity of other data blocks through the second series of Hash values. If there is lost or error in the data blocks, and the first and second series of Hash values, the verifier may locate erroneous data blocks and verify the signature information of the data by querying the original integrity information stored in the security storage device.

FIG. 13 is a schematic block diagram illustrating a data integrity protecting apparatus according to an embodiment of the disclosure. The apparatus 1310 shown in FIG. 13 may adopt the method described in the above embodiments or examples to generate the integrity information and the verification information of the data to be protected, that is the apparatus 1310 may be used as the information generator apparatus (e.g. 410 or 510) described above.

As shown in FIG. 13, the apparatus 1310 may include a data dividing device 1312, an integrity information generating device 1314, and a verification information generating device 1316.

The data dividing device 1312 may be configured to divide the data to be protected into a plurality of data blocks. The data dividing device 1312 may adopt the method described in the above embodiments or examples to divide the data, the description of which is not repeated.

The integrity information generating device 1314 may be configured to calculate the Hash value of each data block received from the data dividing device by using a Hash function (referred to as the first Hash function), thus obtaining a plurality of block Hash values. These block Hash value form the first series of Hash values. Then the integrity information generating device 1314 may further calculate the second series of Hash values based on the the first series of Hash values by using a Hash function (referred to as the second Hash function). The second series of Hash values includes a plurality of chain Hash values, each of which is associated with a corresponding block Hash value in the first series of Hash values and is associated with a neighbor chain Hash value in the second series of Hash values. The integrity information generating device 1314 may adopt the method described in the above embodiments or examples to generate the first series of Hash values and the second series of Hash values. The first and second Hash functions may be the same Hash function, or may be Hash functions different from each other, the detailed description of which is not repeated.

The first series of Hash values and the second series of Hash values may be used as the integrity information of the data to be protected.

The verification information generating device 1316 may utilize the last chain Hash value of the second series of Hash values to generate the verification information of the data. The verification information generating device 1316 may adopt the method described in the above embodiments or examples to generate the verification information, which may be digital signature and/or time stamp information of the data, the disclosure is not limited to any particular example herein.

As an example, the apparatus 1310 may further include a transmitting device 1318 configured to transmit the data and the generated verification information to the information receiving party (e.g. the information verifier 420). As a particular example, the transmitting device 1318 may transmit the integrity information to the information receiving party, together with the data and the verification information.

The integrity information generated by the integrity information generating device 1314 may be stored in a security storage device 1330. As an example, the security storage device may be independent of the apparatus 1310. As another example, the security storage device may be a component of the apparatus 1310. The security storage device may be a nonvolatile memory, to endure the security of the integrity information.

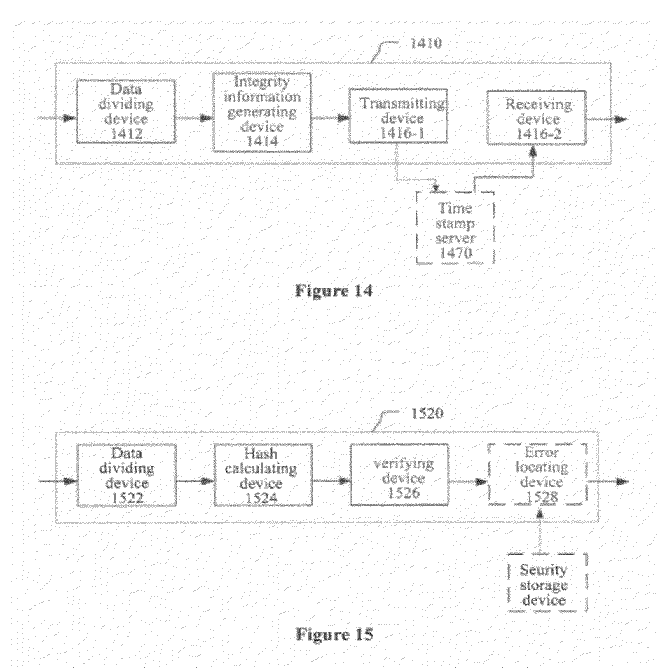

FIG. 14 is a schematic block diagram illustrating a data integrity protecting apparatus according to another embodiment of the disclosure. The apparatus 1410 may adopt the method described in the above embodiments or examples to generate the integrity information and the verification information of the data, and may be used as the information generator apparatus (e.g. 510) described in the above embodiments or examples. Different from the embodiment of FIG. 13, the apparatus 1410 may generate the time stamp of the data via an external time stamp server.

As shown in FIG. 14, the apparatus 1410 may include a data dividing device 1412, an integrity information generating device 1414, a transmitting device 1416-1 and a receiving device 1416-2.

The data dividing device 1412, which is similar to the data dividing device 1312 shown in FIG. 13, is configured to divide the data to be protected into a plurality of data blocks. The data dividing device 1412 may adopt the method described in the above embodiments or examples, the description of which is not repeated.

The integrity information generating device 1414, which is similar to the generating device 1314 shown in FIG. 13, is configured to calculate the Hash value of each data block received from the data dividing device by using the first Hash function, thus obtaining a plurality of block Hash values. These block Hash values form the first series of Hash values. Then the integrity information generating device 1414 may further calculate the second series of Hash values based on the first series of Hash values by using the second Hash function. The second series of Hash values includes a plurality of chain Hash values, each of which is associated with a corresponding block Hash value in the first series of Hash values and is associated with a neighbor chain Hash value in the second series of Hash values. The integrity information generating device 1414 may adopt the method described in the above embodiments or examples to generate the first series of Hash values and the second series of Hash values. The first and second Hash functions herein may be the same Hash function, or may be Hash functions different from each other, the description of which is not repeated.

The generated first series of Hash values and second series of Hash values may be used as the integrity information of the data to be protected.

The transmitting device 1316-1 may transmit the last chain Hash value in the second series of Hash values to the time stamp server 1470. The time stamp server 1470 may generate a time stamp file based on the last chain Hash value by using any appropriate method and return the time stamp file to the apparatus 1410. The receiving device 1316-2 may receive the time stamp information returned from the time stamp server, and utilize the time stamp information as the verification information of the data to be protected.

The integrity information generated by the integrity information generating device 1414 may be stored in a security storage device (not shown in FIG. 14). As an example, the security storage device may be independent of the apparatus 1410. As another example, the security storage device may be a component of the apparatus 1410. The security storage device may be a nonvolatile memory to ensure the security of the integrity information.

The above described apparatus 1410 or 1310 may further include a data storage device (not shown), to store the data to be protected and the verification information.

FIG. 15 is a schematic block diagram illustrating a data integrity verifying apparatus according to an embodiment of the disclosure. The apparatus 1520 may adopt the method described in the above embodiments or examples to verify the integrity of data, and may be used as the information verifier apparatus (e.g. 420 or 520) described in the above embodiments or examples.

As shown in FIG. 15, the apparatus 1520 may include a data dividing device 1522, a Hash calculating device 1524, and a verifying device 1526.

The data dividing device 1522 may be configured to divide data to be verified into a plurality of data blocks. The data dividing device 1522 may utilize the method described in the above embodiments or examples to divide the data, the description of which is not repeated.

The Hash calculating device 1524 may be configured to calculate the Hash value of each data block received from the data dividing device 1522 by using the first Hash function, thus obtaining a plurality of block Hash values. These block Hash values form the first series of Hash values. Then the Hash calculating device 1524 may further calculate the second series of Hash values based on the first series of Hash values by using the second Hash function. The second series of Hash values includes a plurality of chain Hash values, each of which is associated with a corresponding block Hash value in the first series of Hash values and is associated with a neighbor chain Hash value of the second series of Hash values. The Hash calculating device 1314 may adopt the method described in the above embodiments or examples to generate the first series of Hash values and the second series of Hash values, the description of which is not repeated.

The verifying device 1526 may be configured to determine the integrity of the data to be verified according to the last chain Hash value in the second series of Hash values generated by the Hash calculating device 1524 based on the data to be verified and the verification information of data to be verified. The verification information of data to be verified may include the digital signature and/or time stamp information of the data. Of course, the disclosure is not limited to these. The verifying device 1526 may utilize the method as shown in FIG. 7 or FIG. 8 to verify the integrity of the data, the description of which is not repeated.

As an example, the apparatus 1520 may further include an error locating device 1528. The error locating device 1528 may, when the verifying device 1526 determines that the data to be verified is not in integrity, obtain the original integrity information of the original data, and locate the data block containing error in the data to be verified by using the original integrity information. The original integrity information may include the first series of Hash values and the second series of Hash values generated by the information generator based on the original data. The first series of Hash values of the original data includes a plurality of block Hash values (referred to as original block Hash values), and the second series of Hash values of the original data includes a plurality of chain Hash values (referred to as original chain Hash values). As examples, the error locating device 1528 may adopt the method described above with reference to FIG. 9 or FIG. 10 or FIG. 11 to locate the data block containing error, and to further verify the verification information (signature information and/or time stamp information) of the data.

In the embodiments of the disclosure, the above mentioned structure of double Hash chain (the first series of Hash values and the second series of Hash values) is used in the protection of data integrity. In such methods, apparatuses and systems, the integrity information of the data may be generated rapidly. By using the double Hash chain in which the second series of Hash values may chain the block Hash values of the first series of Hash values in sequence, when there is lost or error in some part of the data, the position or region of the erroneous data block in the data may be rapidly located. In addition, the block Hash values in the first series of Hash values has a one-to-one corresponding relationship with the data blocks, thus even in the case that some data blocks are lost or erroneous, the verifier is enabled to verify the integrity of the other parts of the data. In addition, the methods, apparatus or systems according to the embodiments of the disclosure are capable of keeping balance between data security and system overhead.

The methods, apparatus or systems according to the embodiments of the disclosure may be applied to not only data protection in data transmission system, but also data protection in data storage system. For example, they may be applied to a variety of scenarios, such as video monitoring, intellectual property protection, data transmission, and the like, and may provide a flexible and robust data integrity protection in these scenarios.

In addition, in some embodiments and/or examples of the disclosure, the storage device for storing the integrity information may be a trusted third party. In some other embodiments and/or examples, the storage device for storing the integrity information may be a nonvolatile memory, to ensure the security storage of the integrity information while avoiding the need of a trusted third party.

It should be understood that the above embodiments and examples are illustrative, rather than exhaustive. The present disclosure should not be regarded as being limited to any particular embodiments or examples stated above. In addition, some expressions in the above embodiments and examples contain the word “first” or “second” or the like. As can be understood by those skilled in the art such expressions are merely used to literally distinguish the terms from each other and should not be regarded as any limiting to such as the sequence thereof.

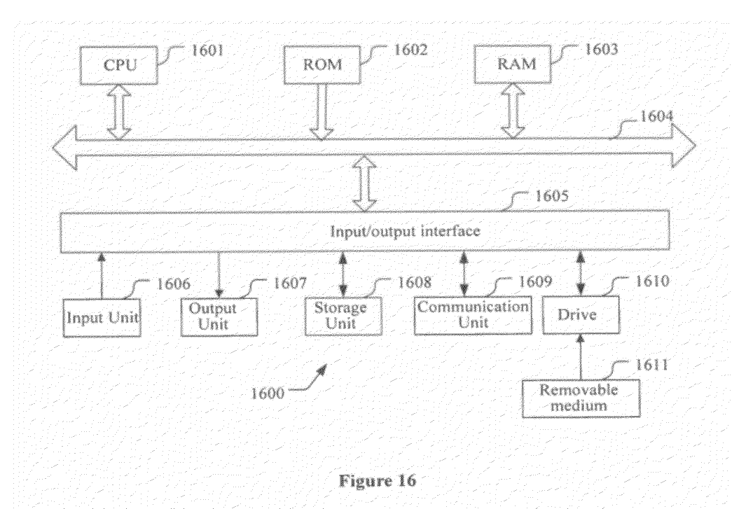

As an example, the components, units or steps in the above apparatuses and methods can be configured with software, hardware, firmware or any combination thereof. As an example, in the case of using software or firmware, programs constituting the software for realizing the above method or apparatus can be installed to a computer with a specialized hardware structure (e.g. the general purposed computer 1600 as shown in FIG. 16) from a storage medium or a network. The computer, when installed with various programs, is capable of carrying out various functions.

In FIG. 16, a central processing unit (CPU) 1601 executes various types of processing in accordance with programs stored in a read-only memory (ROM) 1602, or programs loaded from a storage unit 1608 into a random access memory (RAM) 1603. The RAM 1603 also stores the data required for the CPU 1601 to execute various types of processing, as required. The CPU 1601, the ROM 1602, and the RAM 1603 are connected to one another through a bus 1604. The bus 1604 is also connected to an input/output interface 1605.

The input/output interface 1605 is connected to an input unit 1606 composed of a keyboard, a mouse, etc., an output unit 1607 composed of a cathode ray tube or a liquid crystal display, a speaker, etc., the storage unit 1608, which includes a hard disk, and a communication unit 1609 composed of a modem, a terminal adapter, etc. The communication unit 1609 performs communicating processing. A drive 1610 is connected to the input/output interface 1605, if needed. In the drive 1610, for example, removable media 1611 is loaded as a recording medium containing a program of the present invention. The program is read from the removable media 1611 and is installed into the storage unit 1608, as required.

In the case of using software to realize the above consecutive processing, the programs constituting the software may be installed from a network such as Internet or a storage medium such as the removable media 1611.

Those skilled in the art should understand the storage medium is not limited to the removable media 1611, such as, a magnetic disk (including flexible disc), an optical disc (including compact-disc ROM (CD-ROM) and digital versatile disk (DVD)), an magneto-optical disc (including an MD (Mini-Disc) (registered trademark)), or a semiconductor memory, in which the program is recorded and which are distributed to deliver the program to the user aside from a main body of a device, or the ROM 1602 or the hard disc involved in the storage unit 1608, where the program is recorded and which are previously mounted on the main body of the device and delivered to the user.

The present disclosure further provides a program product having machine-readable instruction codes which, when being executed, may carry out the methods according to the embodiments.

Accordingly, the storage medium for bearing the program product having the machine-readable instruction codes is also included in the disclosure. The storage medium includes but not limited to a flexible disk, an optical disc, a magneto-optical disc, a storage card, or a memory stick, or the like.

In the above description of the embodiments, features described or shown with respect to one embodiment may be used in one or more other embodiments in a similar or same manner, or may be combined with the features of the other embodiments, or may be used to replace the features of the other embodiments.

As used herein, the terms the terms “comprise,” “include,” “have” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

Further, in the disclosure the methods are not limited to a process performed in temporal sequence according to the order described therein, instead, they can be executed in other temporal sequence, or be executed in parallel or separatively. That is, the executing orders described above should not be regarded as limiting the method thereto.

While some embodiments and examples have been disclosed above, it should be noted that these embodiments and examples are only used to illustrate the present disclosure but not to limit the present disclosure. Various modifications, improvements and equivalents can be made by those skilled in the art without departing from the scope of the present disclosure. Such modifications, improvements and equivalents should also be regarded as being covered by the protection scope of the present disclosure.

What is claimed is:

1. A data integrity protecting method, comprising:
dividing data into a plurality of data blocks;
calculating a Hash value of each of the data blocks by using a first Hash function, to obtain a plurality of block Hash values which form a first series of Hash values;
calculating a second series of Hash values based on the first series of Hash values by using a second Hash function, the second series of Hash values comprising a plurality of chain Hash values, each of which being associated with a corresponding block Hash value in the first series of Hash values and being associated with a neighbor chain Hash value in the second series of Hash values; and
generating verification information of the data by using a last chain Hash value in the second series of Hash values.

2. The method of claim 1, wherein calculating the second series of Hash values based on the first series of Hash values comprises:
calculating a Hash value, as a first chain Hash value of the second series of Hash values, by using block Hash values of first two or more data blocks in the plurality of data blocks as independent variables of the second Hash function; and
calculating each chain Hash value from a second one in the second series of Hash values by using a preceding chain Hash value and a corresponding block Hash value as independent variables of the second Hash function.

3. The method of claim 1, wherein calculating the second series of Hash values based on the first series of Hash values comprises:
calculating a Hash value, as a first chain Hash value of the second series of Hash values, by using a block Hash value of the first data block in the plurality of data blocks and a specified initialization value as independent variables of the second Hash function; and
calculating each chain Hash value from a second one in the second series of Hash values by using a preceding chain Hash value and a corresponding block Hash value as independent variables of the second Hash function.

4. The method of claim 1, wherein generating verification information of the data by using the last chain Hash value in the second series of Hash values comprises:
generating signature information by performing a signature operation to the last chain Hash value in the second series of Hash values, as the verification information of the data, and
wherein the method further comprises:
sending the data and the signature information to an information receiving party.

5. The method of claim 1, further comprising:
sending the first series of Hash values and/or the second series of Hash values to an information receiving party.

6. The method of claim 1, wherein the verification information is time stamp information of the data, and generating the verification information of the data by using the last chain Hash value in the second series of Hash values comprises:
sending the last chain Hash value to a time stamp server; and
receiving time stamp information returned from the time stamp server, wherein the time stamp information is generated by the time stamp server using the last chain Hash value and time information.

7. A data integrity protecting apparatus, comprising:
a data dividing device configured to divide data into a plurality of data blocks;
the integrity information generating device configured to calculate a Hash value of each of the data blocks by using a first Hash function, to obtain a plurality of block Hash values which form a first series of Hash values, and further configured to calculate a second series of Hash values based on the first series of Hash values by using a second Hash function, the second series of Hash values comprising a plurality of chain Hash values, each of which being associated with a corresponding block Hash value in the first series of Hash values and being associated with a neighbor chain Hash value in the second series of Hash values; and
a verification information generating device configured to generate verification information of the data by using a last chain Hash value in the second series of Hash values.

8. A data integrity verifying method, comprising:
dividing data to be verified into a plurality of data blocks;
calculating a Hash value of each of the data blocks by using a first Hash function, to obtain a plurality of block Hash values which form a first series of Hash values;
calculating a second series of Hash values based on the first series of Hash values by using a second Hash function, the second series of Hash values comprising a plurality of chain Hash values, each of which being associated with a corresponding block Hash value in the first series of Hash values and being associated with a neighbor chain Hash value in the second series of Hash values; and
determining whether the data to be verified is in integrity according to a last chain Hash value of the second series of Hash values and verification information of the data to be verified.

9. The method of claim 8, wherein calculating the second series of Hash values based on the first series of Hash values comprises:
calculating a Hash value, as a first chain Hash value of the second series of Hash values, by using block Hash values of first two or more data blocks in the plurality of data blocks as independent variables of the second Hash function; and
calculating each chain Hash value from a second one in the second series of Hash values by using a preceding chain Hash value and a corresponding block Hash value as independent variables of the second Hash function.

10. The method of claim 8, wherein calculating the second series of Hash values based on the first series of Hash values comprises:
calculating a Hash value, as a first chain Hash value of the second series of Hash values, by using a block Hash value of the first data block in the plurality of data blocks and a specified initialization value as independent variables of the second Hash function; and
calculating each chain Hash value from a second one in the second series of Hash values by using a preceding chain Hash value and a corresponding block Hash value as independent variables of the second Hash function.

11. The method of claim 8, further comprising:
if determining the data to be verified is not in integrity, obtaining information from a security storage device which stores integrity information of original data and locating a data block containing error in the data to be verified by using the obtained information,
wherein the integrity information of the original data comprises a first series of Hash values and a second series of Hash values of the original data, the first series of Hash values of the original data contains a plurality of original block Hash values calculated based on a plurality of data blocks obtained by dividing the original data and the second series of Hash values of the original data contains a plurality of original chain Hash values calculated based on the first series of Hash values of the original data.

12. The method of claim 11, wherein locating the data block containing error in the data to be verified comprises steps of:
obtaining, starting from a last chain Hash value in the second series of Hash values of the data to be verified, an original block Hash value of a data block corresponding to the last chain Hash value and an original chain Hash value corresponding to a preceding chain Hash value from the security storage device;
determining whether a block Hash value of the last data block of the data to be verified is the same with corresponding original block Hash value, and if yes, determining the last data block of the data to be verified contains error; and
further determining whether the preceding chain Hash value is the same with its corresponding original chain Hash value, and if yes, determining all data blocks preceding the last data block contain no error, otherwise, repeating the obtaining and determining steps until all data block containing errors in the data to be verified are found.

13. The method of claim 11, wherein locating the data block containing error in the data to be verified comprises:
obtaining two or more original chain Hash values of the second series of Hash values of the original data from the security storage device and determining a region including the data block containing error in the data to be verified based on the original chain Hash values.

14. The method of claim 11, wherein locating the data block containing error in the data to be verified comprises:
obtaining all original block Hash values corresponding to the plurality of data blocks of the data to be verified from the security storage device; and
comparing each of the calculated plurality of block Hash values with its corresponding original block Hash value, to locate the data block containing error.

15. A data integrity verifying apparatus, comprising:
a data dividing device configured to divide data to be verified into a plurality of data blocks;
a Hash calculating device configured to calculate a Hash value of each of the plurality of data blocks by using a first Hash function, to obtain a plurality of block Hash values which form a first series of Hash values and further configured to calculate a second series of Hash values based on the first series of Hash values by using a second Hash function, the second series of Hash values comprising a plurality of chain Hash values, each of which being associated with a corresponding block Hash value in the first series of Hash values and being associated with a neighbor chain Hash value in the second series of Hash values; and
a verifying device configured to determine whether the data to be verified is in integrity according to a last chain Hash value in the second series of Hash values and verification information of the data to be verified.

16. The apparatus of claim 15, wherein the Hash calculating device is further configured to calculate the second series of Hash values by:
calculating a Hash value, as a first chain Hash value of the second series of Hash values, by using block Hash values of first two or more data blocks in the plurality of data blocks as independent variables of the second Hash function; and
calculating each chain Hash value from a second one in the second series of Hash values by using a preceding chain Hash value and a corresponding block Hash value as independent variables of the second Hash function.

17. The apparatus of claim 15, wherein the Hash calculating device is further configured to calculate the second series of Hash values by:
calculating a Hash value, as a first chain Hash value of the second series of Hash values, by using a block Hash value of the first data block in the plurality of data blocks and a specified initialization value as independent variables of the second Hash function; and
calculating each chain Hash value from a second one in the second series of Hash values by using a preceding chain Hash value and a corresponding block Hash value as independent variables of the second Hash function.

18. A data integrity protecting system, comprising a data integrity protecting apparatus and a data integrity verifying apparatus, wherein
the data integrity protecting apparatus, comprising:
a data dividing device configured to divide data into a plurality of data blocks,
the integrity information generating device configured to calculate a Hash value of each of the data blocks by using a first Hash function, to obtain a plurality of block Hash values which form a first series of Hash values, and further configured to calculate a second series of Hash values based on the first series of Hash values by using a second Hash function, the second series of Hash values comprising a plurality of chain Hash values, each of which being associated with a corresponding block Hash value in the first series of Hash values and being associated with a neighbor chain Hash value in the second series of Hash values, and
a verification information generating device configured to generate verification information of the data by using a last chain Hash value in the second series of Hash values; and
the data integrity verifying apparatus, comprising:
a data dividing device configured to divide data to be verified into a plurality of data blocks,
a Hash calculating device configured to calculate a Hash value of each of the plurality of data blocks by using a first Hash function, to obtain a plurality of block Hash values which form a first series of Hash values and further configured to calculate a second series of Hash values based on the first series of Hash values by using a second Hash function, the second series of Hash values comprising a plurality of chain Hash values, each of which being associated with a corresponding block Hash value in the first series of Hash values and being associated with a neighbor chain Hash value in the second series of Hash values, and
a verifying device configured to determine whether the data to be verified is in integrity according to a last chain Hash value in the second series of Hash values and verification information of the data to be verified.
